(19) United States
(12) Patent Application Publication
(10) Pub. No.: US 2004/0262849 A1
(43) Pub. Date: Dec. 30, 2004

(54) Cylinder-head gasket comprising an edge-to-edge stop ring

(76) Inventor: Frederic Jean-Michel Pepin, Jove Lei Tours (FR)

Correspondence Address: HARNESS, DICKEY & PIERCE, P.L.C., P.O. BOX 828, BLOOMFIELD HILLS, MI, 48303, US

(21) Appl. No.: 10/484,531

(22) PCT Filed: Jul. 22, 2002
(86) PCT No.: PCT/FR02/02617

(30) Foreign Application Priority Data
Jul. 23, 2001 (FR) 01/09810
Jul. 23, 2001 (FR) 01/09808

(51) Int. Cl. F02F 11/00

(52) U.S. Cl. 277/592

(57) ABSTRACT

The present invention relates to a gasket, particularly a cylinder head gasket, comprising an edge-to-edge stopper. More particularly, the present invention relates to a multisheet cylinder head gasket comprising at least two sheets of which at least one is ribbed.

### CROSS-REFERENCE TO RELATED APPLICATIONS

This application is a National Stage of International Application No. PCT/FR02/02617, filed Jul. 22, 2002. This application claims the benefit of French Patent Applications 01/09810 and 01/09808, both filed on Jul. 23, 2001. The disclosures of the above applications are incorporated herein by reference.

### FIELD OF THE INVENTION

The present invention relates to a gasket, particularly a cylinder head gasket, comprising an edge-to-edge stopper. More particularly, the present invention relates to a multi-sheet cylinder head gasket comprising at least two sheets, of which at least one is ribbed.

### BACKGROUND OF THE INVENTION

As shown in FIG. 1, a cylinder head gasket 10 comprises two sheets 12 with at least one opening 14 that corresponds to the opening of a combustion chamber. At least one of the two sheets, and preferably both, comprise a rib 16 disposed around each opening at a distance from the edge of the opening. The ribs are deformed toward the interior of the gasket.

In addition, gasket 10 comprises an intermediate support sheet 18 that is interposed between the two external sheets 12 and opposite ribs 16, as well as a stopper 20 that is in the form of an annular lining. The annular lining has an internal diameter that corresponds to that of the opening, and an external diameter that is smaller than that of the ribs. The stopper is disposed from edge to edge, along the extension of the support sheet.

The stopper 20 has a thickness X1 greater than a thickness X2 of the support sheet, thus constituting a limiter against the crushing of the ribs and a first tightness barrier. The stopper, however, permits the arching of at least one external sheet 12 to limit the deflection of the latter during use.

According to the prior art, at least a part of the support sheet is always interposed between the ribs. The sheets are laminated products, the thickness and dimensional tolerances of which are imposed by their fabrication, and are not very accurate. To ensure proper functioning of the cylinder head gasket, it is important to control, very accurately, the rib spacing when the ribs are in contact with the interposed element.

Although the stopper is normally immobilized in the transverse direction by the support sheet, and in the vertical direction by the external sheets, a rigid connection between the stopper and the support sheet is necessary because of the flexibility of the external ribbed sheets 12 which can form a gap and thus enable the stopper 20 to slide between the support sheet 18 and one of the external sheets 12.

The connection between stopper 20 and support sheet 18 is generally accomplished by welding, gluing or the like. Patent application FR-00.12669, filed in the name of Applicant. proposes a method for fixing the stopper to its support sheet by radial expansion of the stopper.

### SUMMARY OF THE INVENTION

The present invention proposes a novel cylinder head gasket comprising an edge-to-edge stopper without a rigid connection between the stopper and the support sheet. Although the stopper is without a rigid connection, the stopper is nevertheless perfectly kept in position.

To this end, the present invention provides a cylinder head gasket with at least one opening corresponding to a combustion chamber that comprises at least two sheets referred to as external sheets, at least one of which comprises a circular rib that surrounds the opening and is disposed a distance d from the edge of the opening. In another embodiment, a support sheet may be disposed between the external sheets that comprises an opening that has a diameter that is greater than the opening of the external sheets to define a space in which a stopper is disposed in the form of an annular lining. The annular lining has an internal diameter that corresponds to that of the opening, and an external diameter that is approximately adjusted to the opening of the support sheet to be disposed from edge to edge, wherien the support sheet has a contact surface that is greater than the contact surface of the stopper it faces.

According to a preferred embodiment, this difference in contact surfaces is obtained by a plastic deformation of the edge of the support sheet, the latter presenting cuts so as to form tabs that are slightly folded, preferably in an alternating manner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a cylinder head gasket according to the prior art;

FIG. 2 is a top view of a multi-cylinder head gasket according to a principle of the present invention;

FIG. 3 is a cross-sectional view of the cylinder head gasket of FIG. 2;

FIG. 4A is a cross-sectional view of a cylinder head gasket according to a principle of the invention in a resting position; and

FIG. 4B is a cross-sectional view of a cylinder head gasket according to a principle of the invention showing the flexibility of the external sheets.

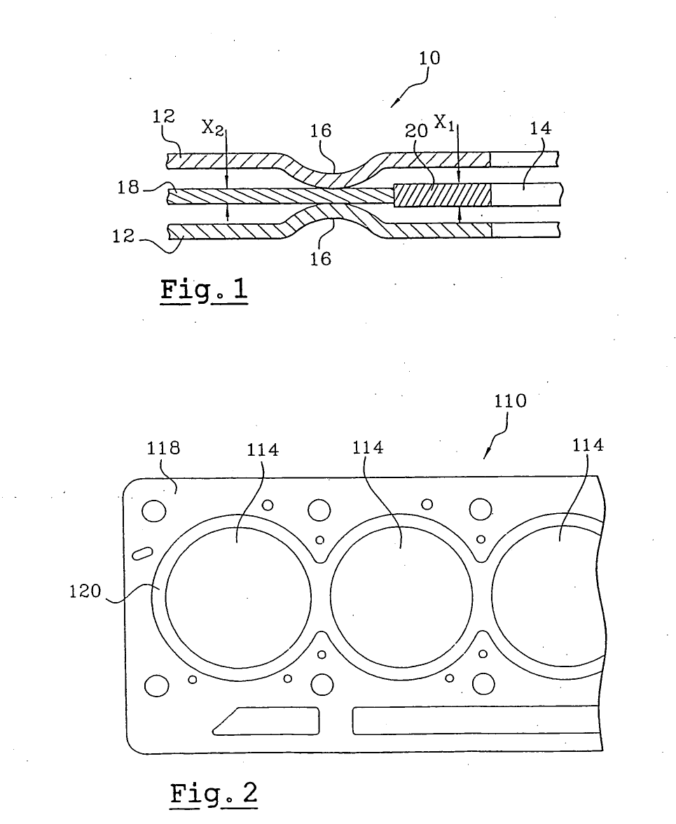

### DETAILED DESCRIPTION OF THE PREFERRED EMBODIMENTS

The following description of the preferred embodiment(s) is merely exemplary in nature and is in no way intended to limit the invention, its application, or uses.

The different figures show a cylinder head gasket 110 comprising at least two external sheets 112 with at least one opening 114 corresponding to a combustion chamber of an engine block. At least one of the external sheets 112, and preferably two, comprise a circular rib 116 that surrounds the opening 114 and are disposed a distance d from the edge of opening 114. The rib(s) are deformed toward the interior of the gasket.

In a known manner, one intermediate support sheet 118 is interposed between the exterior sheets 112. Support sheet 118 contains an opening that is concentric with the opening 114 of external sheets 112 with a diameter greater than the opening 114 to define a space in which is a stopper 120 is disposed in the form of an annular lining. The annular lining has an internal diameter that corresponds to that of the opening 114, and an external diameter that is approximately adjusted to the opening of the support sheet to be disposed from edge to edge.

The stopper comprises at least one zone 122 of a thickness X1 which is greater than a thickness X2 of the support sheet 118 to form a limiter against the crushing of the ribs and a first barrier of tightness. The thickness X1 that is greater than the thickness X2, however, permits the arching of at least one external sheet 12 to limit the deflection of the latter during operation.

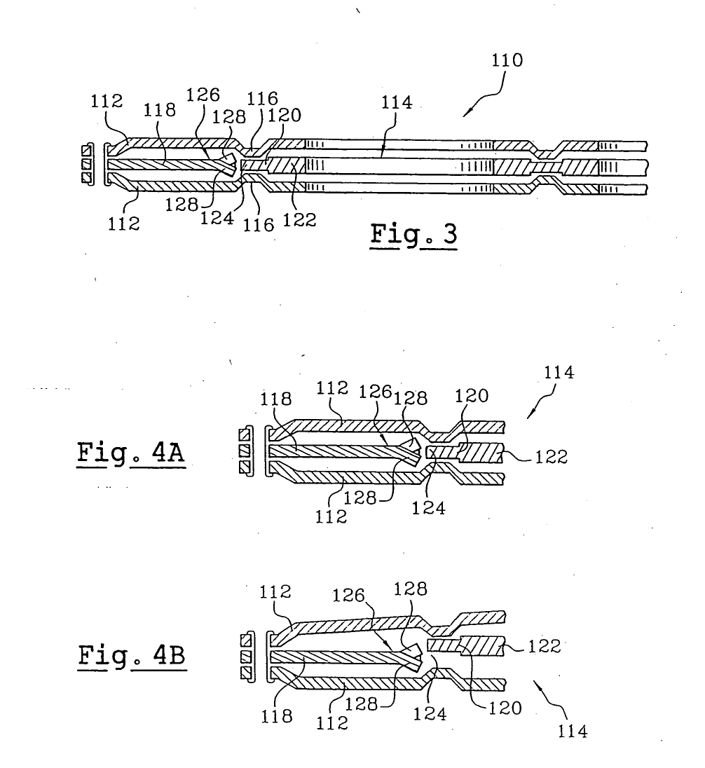

Depending on the case, the external diameter of stopper 120 can be smaller than that of ribs 116 so that the support sheet 118 fits between ribs 116, or the external diameter of the stopper 120 can be greater than that of ribs 116, as illustrated by FIGS. 3, 4A and 4B, so that a zone 124 of the stopper that has a thickness smaller than X1 fits between the ribs 116, as illustrated in FIG. 3.

The advantage of this last variant lies in the possibility of fitting between ribs 116, a piece of relatively high accuracy, a stopper that is perfectly calibrated. The last variant also allows the obtainment of an inter-cylinder distance between openings 114 which is reduced by the fact that only the stopper 120 is disposed between the openings 114, as illustrated in FIG. 2. Of course, this embodiment, referred to as the wide stopper, can be envisaged as being provided with any other means of immobilization or fixation of the stopper to the intermediate support sheet.

Stopper 120 can be a metallic type or be made of a fibrous material as described in patent application FF-01.06129, filed in the name of Applicant.

According to another characteristic of the present invention, the stopper can have a tapered profile along its periphery. Thus, its thickness can be varied to obtain a constant contact pressure despite localized compressive stresses.

According to the invention, to uphold the stopper, the stopper sheet 118 has a contact surface that is greater than the contact surface of the stopper 120 it faces.

According to the embodiment illustrated in FIGS. 3, 4A and 4B, the difference in contact surfaces is obtained by a plastic deformation of an edge 126 of the support sheet 118 to increase its contact surface. From a given sheet thickness, possibly equal to that used in the prior art, it is thus possible to artificially increase the contact surface, wherein the contact surface has a fictitious thickness that corresponds to the distance between the highest points and the lowest points of the deformation.

According to a first variant of the above described embodiment, the edge 126 may contain undulations.

According to another variant of the above embodiment, illustrated by FIGS. 3, 4A and 4B, the edge 126 presents cuts to form tabs 128 that are slightly folded. Some of these tabs may be formed upward with the others being formed downward. Preferably, the tabs are formed upwards and downwrads in an alternating manner.

According to another aspect of the present invention, a plastic stop is obtained which is capable of preventing the stopper from sliding between the support sheet and one of the external sheets when the latter ones form a gap. This stop can be formed by embossing, or by cutting and folding, thus making it possible to obtain a fictitious thickness of the upper support sheet of the stopper. This stop is preferably plastic because, if needed, it can be compressed during the installation of the gasket.

According to another variant, the support sheet 118 can consist of two sheets which have a profile that is adapted to enhance the elastic characteristics of the support sheet 118.

It will be understood that the invention is not limited to the embodiments represented and described hereinabove, but that, on the contrary, it can cover all variants, particularly as regards the profile of the stopper, the materials used, the fabrication of the sheets, each of which can consist of a stack of sheets, as well as the profiles and positions of the ribs.

The description of the invention is merely exemplary in nature and, thus, variations that do not depart from the gist of the invention are intended to be within the scope of the invention. Such variations are not to be regarded as a departure from the spirit and scope of the invention.

1. A cylinder head gasket with at least one opening corresponding to a combustion chamber comprising:
at least two external sheets, at least one of which comprises a circular rib surrounding the opening and disposed at a distance from an edge of said opening; and
a support sheet disposed between the external sheets and comprising another opening with a diameter greater than the opening of the external sheets so as to define a space where a stopper is disposed in the form of an annular lining having an internal diameter corresponding to that of the opening and an external diameter approximately adjusted to the opening of the support sheet to be disposed from edge to edge,
wherein the support sheet has a contact surface that is greater than the contact surface of the stopper it that the support sheet faces.

2. The head gasket according to claim 1, wherein the difference in contact surfaces is obtained by plastic deformation of the edge of the support sheet.

3. The head gasket according to claim 2, wherein the plastic deformation of the edge is obtained by embossing.

4. The head gasket according to claim 2, wherein the edge presents cuts so as to form tabs that are slightly folded, in an alternating manner.

5. The head gasket according to claim 1, wherein the stopper has an external diameter greater than that of the ribs.

6. The head gasket according to claim 1, wherein at least a part of the stopper disposed opposite the ribs is calibrated.
